(19) United States
(12) Patent Application Publication
(10) Pub. No.: US 2025/0128352 A1
(43) Pub. Date: Apr. 24, 2025

(54) LASER WELDING A STACK OF METAL FOILS TO A METAL SUBSTRATE

(71) Applicant: Coherent, Inc., Santa Clara, CA (US)

(72) Inventors: Ryan BRESCOE, Windsor (CA); Jean-Philippe LAVOIE, Novi, MI (US)

(73) Assignee: Coherent, Inc., Santa Clara, CA (US)

(21) Appl. No.: 18/492,391

(22) Filed: Oct. 23, 2023

(51) Int. Cl. B23K 26/21; B23K 26/0622; B23K 26/073; B23K 101/36; H01M 4/04; H01M 4/66

(52) U.S. Cl. CPC B23K 26/21; B23K 26/0622; B23K 26/0734; H01M 4/0471; H01M 4/661; H01M 4/667; B23K 2101/36

(57) ABSTRACT

A method for laser welding a metal foil stack to a metal substrate includes clamping the foil stack against a support surface of a substrate and irradiating the stack with a beam of laser pulses to weld the foils to the substrate. The beam is a composite beam including a center beam and a surrounding annular beam. An initial series of the laser pulses are incident on the stack at mutually distinct locations on a top surface of the stack, and a subsequent series of the laser pulses are incident on the stack at mutually distinct locations on a side of the stack. The resulting weld nuggets penetrate deeply into the stack, with an average penetration depth that exceeds an average pitch between the weld nuggets. The method is capable of welding more than 100 foils to the substrate. Welded assemblies have been demonstrated to withstand large shear forces.

### TECHNICAL FIELD OF THE INVENTION

The present invention relates in general to laser welding of a stack of metal foils to a metal substrate, in particular as applied to the production of electrochemical batteries such as lithium-ion batteries.

### DISCUSSION OF BACKGROUND ART

There is a strong push towards carbon-emission-free transportation. This effort involves phasing out the large existing fleet of diesel- and gasoline-powered vehicles and replacing these vehicles with electric vehicles. Efficient lithium-ion battery technology is paramount to the success of this effort. The battery capacity must cooperate with the rate of energy consumption to allow for a substantial driving range before recharging.

The basic unit of a lithium-ion battery cell consists of an anode, a cathode, and a separator therebetween. The separator is infused with an electrolyte containing lithium salt. Each of the anode and the cathode includes a current collector in the form of a metal foil. Typically, the metal foil of the anode is made of copper, and the metal foil of the cathode is made of aluminum. Some types of lithium-ion battery cells contain only a single basic unit, while others contain multiple basic units coupled in parallel. In applications requiring high storage capacity, it is common to couple together multiple lithium-ion battery cells in series and/or parallel. For example, a battery pack for an electric vehicle contains multiple battery modules, each containing multiple lithium-ion battery cells. Particularly for electric vehicles, the objective is to achieve the highest possible energy storage capacity per volume and per weight, that is, the highest possible energy density, while keeping the manufacturing cost at an acceptable level.

Lithium-ion battery cells are being manufactured in three different cell-formats: cylindrical, prismatic, and pouch. In a cylindrical cell, a single basic unit (i.e., anode, cathode, and separator) is wound in a jelly-roll fashion and disposed in a rigid metal cylinder. The cylindrical cell is the original format used for lithium-ion batteries and is still widely used, but the cylindrical shape precludes efficient packaging of multiple battery cells in a battery module. A significant amount of the total volume of the module remains unutilized. The prismatic shape is better suited to applications, such as electric vehicles, that require many battery cells and a high energy density. As a result, prismatic lithium ion battery cells are currently the most widely used format in electric vehicles. Pouch cells provide further improvement in terms of achievable energy density, both per volume and per weight. Whereas a prismatic cell has a rigid metal casing similar to that of a cylindrical cell, the casing of the pouch cell is a soft polymer-coated aluminum foil that is both thinner and lighter than the rigid metal casings of prismatic and cylindrical cells.

Some prismatic cells contain a single, basic lithium-ion battery unit wound or folded in a flatter shape than that used in cylindrical cells. Other prismatic cells and most pouch cells contain multiple basic units stacked on each other and electrically coupled in parallel. These stacked-structure cells contain many layers organized in the general configuration anode, separator, cathode, separator, anode, separator, etc. Instead of using multiple independent separator layers, a single separator strip may be folded in a Z-fashion between the multiple anode and cathode layers. Comparing winding of a single basic unit to stacking of multiple basic units, the winding process is simpler and faster than the stacking process. However, the stacked structure has several advantages including higher energy density, faster charging and discharging, and greater flexibility in terms of the overall shape of the battery cell.

In a stacked-structure cell, the current-collecting metal foils of all anodes and cathodes protrude from the side(s) of the multilayer structure. The current-collecting metal foil of all the cathodes form a foil stack that is welded to a metal tab, and the current-collecting metal foil of all the anodes form another foil stack that is welded to another metal tab. It is common to have 20-40 foils in each stack. The thickness of each individual foil is usually between approximately 5 and 20 micrometers (μm). The tab thickness usually exceeds the foil thickness by a factor of about ten or more.

The mechanical attachment and electrical connection of each foil to the respective tab is critical for the integrity, reliability, and performance of batteries based on stacked-structure cell design. However, joining many thin metal foils to a much thicker metal tab is challenging. The completed joint must be strong, durable, and have low electrical resistance. Precision resistance welding is used but relies on interface resistance, and the high thermal conductivity of the metals to be welded means that a high current must be applied. Ultrasonic welding is the most widely used technique but contaminants between foils are an issue in the welded area. If not removed, these contaminants can weaken the weld joint. Laser welding has emerged as an attractive alternative, providing precise delivery of power to minimize overall heat accumulation, while the high laser intensity vaporizes contaminants.

### SUMMARY OF THE INVENTION

The lithium-ion battery industry is pushing towards the manufacture of stacked-structure battery cells with a higher number of layers. This push is part of the continuing effort to increase the energy density of lithium-ion battery packs for electric vehicles. If the number of layers in individual battery cells can be increased, the number of battery cells can be decreased accordingly, while maintaining the same total storage capacity. This improves the energy density of the battery pack for at least two reasons. The ratio of storage capacity to packaging material increases for the individual battery cells. Additionally, fewer electrical connections, typically in the form of busbars, are needed to electrically connect the battery cells within the battery pack, which further increases the energy density of the battery pack. However, increasing the number of layers in a battery cell necessarily corresponds to increasing the number of current-collecting metal foils that need to be stacked and welded to the respective metal tabs. It is proving difficult to weld a stack of more than about 40 foils to a tab using conventional techniques. In ultrasonic welding, for example, the energies required to weld taller foil stacks can damage the welding equipment. Some state-of-the-art laser welding methods are capable of welding up to about 60 foils to a tab.

Disclosed herein is a method for laser welding a stack of metal foils to a metal substrate using deep-penetration welds. The method is capable of reliably welding a relatively large number of foils to the substrate. Successful foil-stack-to-substrate welding has been demonstrated with the present method for stacks containing more than 100 foils, and welded assemblies have been demonstrated to withstand shear forces greater than 700 Newtons without the foils breaking. The method represents an enabling technology for increasing the energy density of stacked-structure battery cells in the electric-vehicle industry.

The present method takes advantage of the unique ability of a laser beam to rapidly deliver a large amount of highly localized energy to a material while minimizing undesirable delocalized heating. As opposed to melting a larger, continuous volume of the foil stack, the present method is tailored to melt deeply penetrating local volumes to form deep-penetration weld nuggets that are relatively separate (although some overlap near the surface is acceptable). These deep-penetration weld nuggets secure the foil stack to the substrate in a manner akin to nails. The method deposits a large amount of energy locally and quickly to form these deep-penetration weld nuggets. This approach minimizes undesirable damage to the foils, such as thinning of individual foils adjacent to the welded region, that may result from more sustained and less localized laser irradiation. The deep-penetration welds thus secure the foil stack to the substrate with high strength while maintaining the integrity of the individual foils in and near the welded region.

The deep-penetration welds are formed by scanning a pulsed laser beam across the metal foil stack to deliver a series of laser pulses. Each laser pulse produces a respective narrow deep-penetration weld. The laser beam is a composite beam including a narrow center beam surrounded by a larger annular beam. The deep-penetration welds are formed primarily by the center beam, while the annular beam provides slightly-less-localized heating that aids the welding process performed by center beam.

In one aspect of the invention, a method for laser welding a metal foil stack to a metal substrate includes steps of clamping a stack of metal foils against a support surface of a metal substrate and irradiating the stack of metal foils with a beam of laser pulses to weld the stack of metal foils to the metal substrate. The beam is a composite beam including a center beam and an annular beam surrounding the center beam. The peak power of the center beam is at least 0.5 kilowatt for each of the laser pulses. The center beam is on for a duration of between 20 and 500 microseconds for each of the laser pulses. The step of irradiating the stack includes scanning the composite beam such that (a) an initial series of the laser pulses are incident on the stack at a respective series of mutually distinct locations on a top surface of a top-most metal foil of the stack facing away from the support surface and (b) a subsequent series of the laser pulses are incident on the stack at a respective series of mutually distinct locations on a side of the stack, the side being between the support surface and the top surface. The irradiating step also includes focusing the composite beam such that a largest transverse 1/e² extent of the center beam is less than 150 μm at the stack.

In another aspect of the invention, a battery includes a metal substrate having a support surface, and a metal foil stack disposed on the support surface. The metal foil stack is welded to the metal substrate by a plurality of weld nuggets extending into the metal foil stack from a surface of the metal foil stack. The weld nuggets include deep-penetration weld nuggets. At least some of the deep-penetration weld nuggets further extend into the metal substrate. The deep-penetration weld nuggets are oriented at an oblique angle with respect to the support surface and have an average penetration depth, from the surface of the metal foil stack, that exceeds an average pitch between nearest-neighbor deep-penetration weld nuggets.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 illustrates a method for laser welding a stack of metal foils to a metal substrate, according to an embodiment. FIG. 1 provides a cross-sectional view of the foil stack and substrate, in an exemplary scenario where the foils are current-collecting foils of a lithium-ion battery cell.

FIG. 2 shows an exemplary transverse profile of a composite laser beam used in the FIG. 1 method.

FIG. 3 indicates exemplary incidence locations of pulses of the composite laser beam onto the foil stack in the FIG. 1 method.

FIG. 4 illustrates the laser irradiation process of the FIG. 1 method in further detail, in an implementation where the composite laser beam is incident on the foil stack at an oblique angle with respect to the supporting surface of the substrate. FIG. 4 also illustrates deep-penetration weld nuggets formed thereby.

FIG. 5 shows an exemplary temporal power profile for an individual laser pulse of the composite laser beam of the FIG. 1 method.

FIGS. 6A and 6B illustrate a technique for scanning the composite laser beam in the FIG. 1 method, according to an embodiment.

FIG. 7 illustrates an exemplary pattern of incidence locations, on the foil stack, irradiated using the scanning technique of FIGS. 6A and 6B.

FIG. 8 is a microscope image of a cross section of an exemplary foil-stack-substrate assembly welded according to the FIG. 1 method, implementing the scanning technique of FIG. 6 and the pattern of FIG. 7.

FIG. 9 illustrates a modification of the FIG. 1 method, wherein the foils are offset from each other such that the irradiated side of the foil stack is slanted, according to an embodiment.

### DETAILED DESCRIPTION OF THE INVENTION

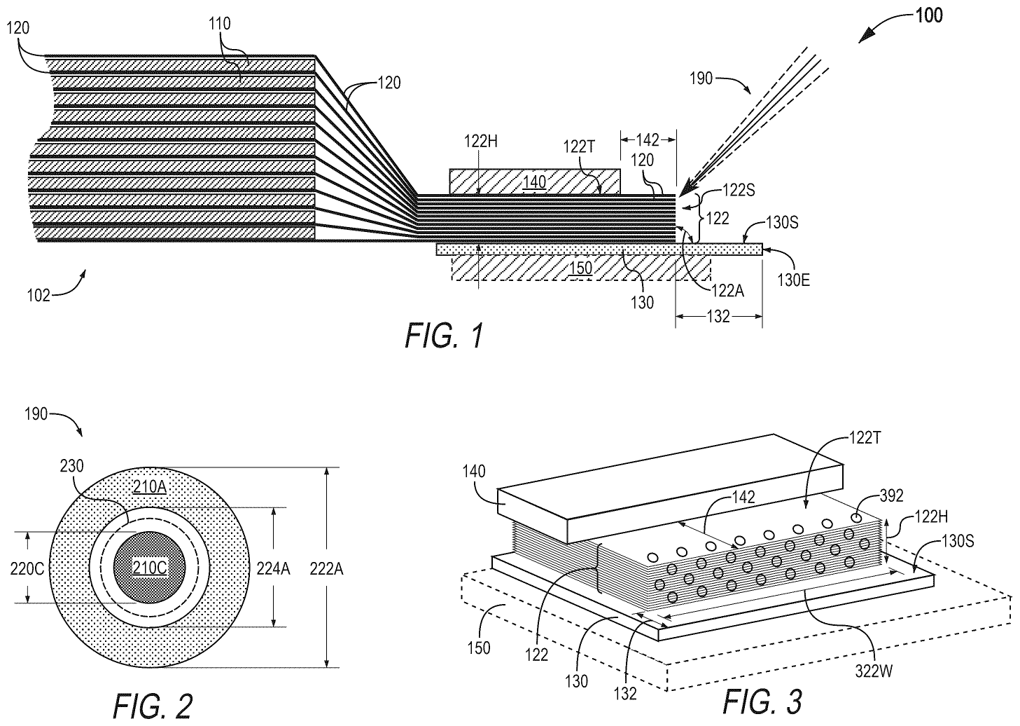

Referring now to the drawings, wherein like components are designated by like numerals, FIG. 1 illustrates one method 100 for laser welding a stack 122 of metal foils 120 to a metal substrate 130. FIG. 1 provides a cross-sectional view of foil stack 122 and substrate 130, in an exemplary scenario where foils 120 are current-collecting foils of a lithium-ion battery cell 102. Method 100 is not limited to this scenario. Rather, method 100 is generally applicable to welding of stacks of metal foils to metal substrates.

In battery cell 102, foils 120 are separated by material layers 110. In one example, foils 120 are current-collectors of cathodes of battery cell 102, and each layer 110 includes two separators and an anode. In this example, each foil 120 may be made of aluminum. In another example, foils 120 are current-collectors of anodes of battery cell 102, and each layer 110 includes two separators and a cathode. In this example, each foil 120 may be made of copper. While FIG. 1 only shows one stack 122 of foils 120 to be welded to substrate 130, battery cell 102 may include two stacks 122 of foils 120, each to be welded to a respective substrate 130 using method 100. One of these stacks includes current-collecting foils of anodes of battery cell 102, and the other stack includes current-collecting foils of cathodes of battery cell 102.

From a laser-welding perspective, it is usually preferred that foils 120 and substrate 130 are made of the same material. Thus, in one embodiment, substrate 130 is of the same material as foils 120. For example, substrate 130 is made of aluminum when foils 120 are made of aluminum, and substrate 130 is made of copper when foils 120 are made of copper. However, when foils 120 and substrate 130 are part of battery cell 102, weight considerations may be more important. In this scenario, substrate 130 may be made of another material than foils 120. For example, substrate 130 may be made of aluminum even if foils 120 are made of another material, e.g., copper.

The thickness of each foil 120 may be less than 20 μm, for example in the range between 5 and 20 μm. The number of foils 120 in foil stack 122 may exceed 40, or 60, or even 100. Foil stack 122 may have a height 122H of 250 μm or more, for example in the range between 250 and 1000 μm. Substrate 130 is significantly thicker than individual foils 120. Substrate 130 may be one or several orders of magnitude thicker than individual foils 120. In one example, the thickness of substrate 130 is at least 250 μm.

Method 100 clamps foil stack 122 against a support surface 130S of substrate 130 and irradiates foil stack 122 with a laser beam 190. Support surface 130S may be planar, with foils 120 being generally parallel to support surface 130S. In the embodiment depicted in FIG. 1, foil stack 122 is clamped between an upper clamp 140 and substrate 130. Substrate 130 may function as a lower clamp, or foil stack 122 and substrate 130 may be clamped between upper claim 140 and a lower clamp 150. Clamps 140 and 150 are tooling that may be removed after method 100 is completed.

When foil stack 122 is clamped against substrate 130, the top surface of a top-most foil 120 of foil stack 122 forms a top surface 122T of foil stack 122 that faces away from support surface 130S. Foil stack 122 has a side 122S where foils 120 terminate. Side 122S may be formed by a cut through foil stack 122 prior to clamping foil stack 122 against substrate 130. When side 122S is formed by cutting foil stack 122, side 122S is typically orthogonal to support surface 130S. In the following, unless mentioned otherwise, side 122S is assumed to be orthogonal to support surface 130S at least to within 10 degrees. That is, unless otherwise mentioned, angle 122A between side 122S and support surface 130S is between 80 and 100 degrees. Clamp 140 is set back from side 122S by a non-zero distance 142 such that a portion of top surface 122T near side 122S is accessible to laser beam 190. Non-zero distance 142 may be between 1 and 3 millimeters in order to provide access for laser beam 190 to top surface 122T while fixing the protruding ends of foils 120. In the depicted embodiment, substrate 130 extends beyond side 122S, such that an end 130E of substrate 130 is a distance 132 from side 122S. Distance 132 may be several millimeters or more. Alternatively, end 130E may be aligned with side 122S, corresponding to distance 132 being zero. Despite foils 120 being clamped between clamp 140 and substrate 130, gaps may exist between at least some of foils 120, especially outside the footprint of clamp 140 on foil stack 122. Such gaps may be caused by non-flatness of foils 120.

Method 100 irradiates foil stack 122 with laser beam 190 while foil stack 122 is clamped against support surface 130S. Depending on the material of foils 120 and substrate 130, the wavelength of laser beam 190 may be in the near-infrared or visible spectral ranges. In one scenario, foils 120 are made of copper or aluminum, and laser beam 190 is near-infrared. For example, the wavelength of laser beam 190 may be in the range between 900 and 1200 nanometers (nm) or, when utilizing an ytterbium-doped laser gain medium/media, in the range between 1030 and 1085 nm. In another scenario, a laser beam 190 having a visible wavelength is used for welding a copper foil stack 122.

FIG. 2 shows a transverse profile of laser beam 190. Laser beam 190 is a composite laser beam that includes a center beam 210C and a surrounding annular beam 210A. Laser beam 190 may be delivered by an optical fiber having a center core and a surrounding annular core. The depicted transverse profile and the following discussion pertain to a focus of laser beam 190 or a location within a Raleigh range of a focus of laser beam 190. In the embodiment depicted in FIG. 2, center beam 210C and annular beam 210A are circular. The following discussion assumes circular beams but is readily extended to elliptical beams.

Center beam 210C has a 1/e²-diameter 220C. Annular beam 210A has an outer 1/e²-diameter 222A and an inner 1/e²-diameter 224A. Inner diameter 224A of annular beam 210A exceeds diameter 220C of center beam 210C. The combined intensity distribution of center beam 210C and annular beam 210A attains a minimum along a circle 230 that is outside diameter 220C of center beam 210C and inside inner diameter 224A of annular beam 210A. In one example, diameter 220C is less than 150 μm or less than 100 μm, e.g., in the range between 15 and 50 μm, and outer diameter 222A is in the range between four and ten times diameter 220C.

In most embodiments of method 100, laser beam 190 is focused at foil stack 122, i.e., in foil stack 122 or on a surface thereof. The Rayleigh range is typically much greater than height 122H. The transverse profile of laser beam 190 thereby exhibits distinct center and annular beams throughout foil stack 122.

Laser beam 190 is pulsed. The duration of individual pulses of laser beam 190 may be a fraction of a millisecond. Laser beam 190 may be generated by modulating on and off the output of a continuous-wave (cw) laser source, such as a fiber laser. Center beam 210C and annular beam 210A may be obtained from the same laser source or from different respective laser sources. In one embodiment, the respective powers of center beam 210C and annular beam 210A are controlled independently of each other, and these two beams may be turned on and off at slightly different times to optimize the laser welding process.

Method 100 scans laser beam 190 along surfaces of foil stack 122. (Center beam 210C and annular beam 210A are scanned together.) The scanning is performed such that laser beam 190 delivers a series of laser pulses to a respective series of mutually distinct locations on the surfaces of foil stack 122.

FIG. 3 is a perspective view of foil stack 122 and substrate 130 (as well as clamps) that schematically indicates exemplary incidence locations 392 of pulses of laser beam 190 onto foil stack 122. Each incidence location is indicated by a circle in FIG. 3. For clarity of illustration, only a single incidence location is labeled. Each incidence location 392 is the location where the center of center beam 210C is incident on foil stack 122.

Referring now to FIGS. 1 and 3 in combination, method 100 scans laser beam 190 such that (a) an initial series of laser pulses are incident on top surface 122T at a respective series of mutually distinct incidence locations 392, and a subsequent series of laser pulses are incident on side 122S at another respective series of mutually distinct incidence locations 392. Incidence locations 392 may be distributed along the full width 322W of foil stack 122. In one example, width 322W is in the range between 25 and 60 millimeters. In one embodiment, laser beam 190 is substantially stationary during each laser pulse, with scanning between incidence locations 392 taking place between laser pulses. In another embodiment, where the pulse duration is negligible compared to the scanning-time between incidence locations 392, laser beam 190 scans continuously without pausing at each incidence location 392.

Method 100 focuses laser beam 190 to achieve an intensity that, for each laser pulse, allows center beam 210C to penetrate deeply into foil stack 122 and, for at least some of the laser pulses, also penetrate into substrate 130. The optimal density of incidence locations 392 is a trade-off between (a) securing foils stack 122 to substrate 130 with the desired strength and (b) maintaining the integrity of foils 120. Foils 120 may be compromised by sustained heating of the same area and/or by excessive overlap between weld nuggets formed at adjacent incidence locations 392. Preferably, incidence locations 392 are separated by a distance that exceeds the largest transverse 1/e² extent of center beam 210C at foil stack 122. This corresponds to the 1/e² width of center beam 210C in any transverse dimension thereof being less than the separation between incident locations 392. In one example, incidence locations 392 are separated by at least 100 μm. When center beam 210 is circular, the largest transverse extent is the 1/e² diameter of center beam 210. If, for example, the center beam 210 is elliptical instead of circular, the largest transverse 1/e² extent is the 1/e² width of center beam 210 along the major axis of the elliptical transverse profile. The separation between incident locations 392 is the same as the center-to-center distance between the respective pairs of pulses of laser beam 190 on foil stack 122, as measured orthogonally to the propagation direction of laser beam 190. More preferably, incidence locations 392 are separated by a distance that is at least twice the largest 1/e² transverse extent of center beam 210C. This corresponds to the 1/e² width of center beam 210C in any transverse dimension thereof being less than half the separation between incident locations 392.

Optionally, method 100 flows a shield gas (not depicted) over the foil-stack-substrate assembly during irradiation by laser beam 190. The shield gas may include nitrogen, a noble gas, or clean dry air.

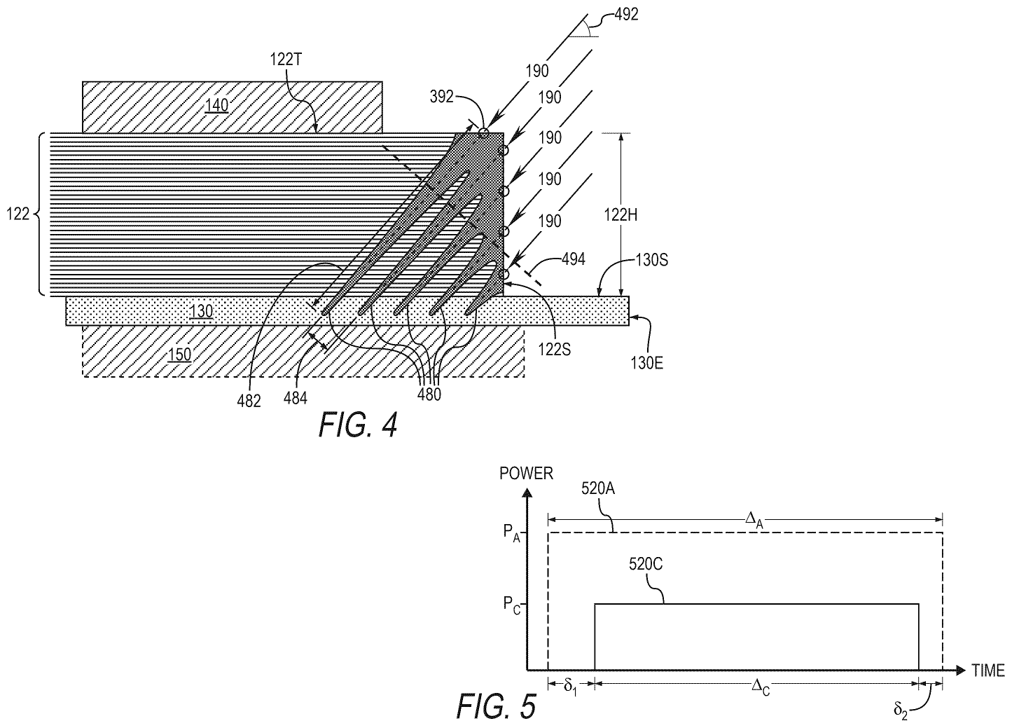

FIG. 4 illustrates, in cross-sectional view, the laser irradiation process of method 100 in further detail, in an implementation where laser beam 190 is incident on foil stack 122 at an oblique angle 492 with respect to support surface 130S. Oblique angle 492 allows for irradiation of both top surface 122T and side 122S while maintaining a fixed spatial relationship between the foil-stack-substrate assembly and a laser processing head directing laser beam 190 toward foil stack 122. Steering of laser beam 190, to access different incidence locations 392 on foil stack 122, may be performed by one or more movable optical elements of the laser processing head. Oblique angle 492 may be in the range between 30 and 60 degrees. FIG. 4 shows laser beam 190 as incident on five different incidence locations 392. Steering of laser beam 190 may result in oblique angle 492 being different for different incidence locations 392. In most scenarios, such differences are negligible.

Laser beam 190 may be focused on or in foil stack 122 to achieve the intensity required for center beam 210C to form deep-penetration welds. In one embodiment, laser beam 190 is focused at a focal plane 494 that coincides with foil stack 122. In this embodiment, it is not necessary to adjust the focusing of laser beam 190 when steered to different incidence locations 392. Focal plane 494 may be slightly curved. Depending on incidence location 392, focal plane 494 may be at a different depth from the surface where laser beam 190 enters foil stack 122. The Rayleigh length of laser beam 190 is typically significantly greater than height 122H of foil stack 122. The welding process is therefore typically not adversely impacted by differences in focusing properties between different incidence locations 392. In another embodiment, the focusing of laser beam 190 is adjusted to be at the same, or similar, depth from the surface where laser beam 190 enters foil stack 122 at each incidence location 392. For example, laser beam 190 may be focused at each incidence location 392. Alternatively, the focus of laser beam 190 may be maintained near support surface 130S during irradiation of each incidence location 392.

FIG. 4 further illustrates deep-penetration weld nuggets 480 formed by method 100. The FIG. 4 cross section is taken to coincide with five deep-penetration weld nuggets 480. The depiction in FIG. 4 is somewhat idealized, showing very clean weld nuggets 480, planar top surface 122T and side 122S, and a ninety-degree corner between top surface 122T and side 122S. In practice, welded foil-stack-substrate assemblies may exhibit irregularities and variation in the shapes of weld nuggets 480, deviations from planarity of top surface 122T and side 122S, and rounding of the corner between top surface 122T and side 122S.

Each weld nugget 480 is generated by a respective pulse of laser beam 190 when incident on foil stack 122 at a respective incidence location 392. Each weld nugget 480 extends into foil stack 122 along a longitudinal axis that at least approximately corresponds to the propagation direction of laser beam 190. Each weld nugget 480 has a penetration depth 482 from the surface of foil stack 122 as welded. Penetration depth 482 is measured along the propagation direction of laser beam 190 or, substantially equivalently, along the resulting longitudinal axis of weld nugget 480. Weld nuggets 480 are characterized by a relatively large penetration depth 482, e.g., greater than 0.25 mm or greater than 0.5 mm. In one embodiment, the average penetration depth 482 of weld nuggets 480 exceeds the average pitch 484 between nearest-neighbor weld nuggets 480. The average penetration depth 482 may be at least twice the average pitch 484 between nearest-neighbor weld nuggets 480. Pitch 484 is measured orthogonally to the propagation direction of laser beam 190 or orthogonally to the longitudinal axes of weld nugget 480. Pitch 484 at least approximately equals the distance between the corresponding incidence locations 392, as measured orthogonally to the propagation direction of laser beam 190.

Some weld nuggets 480 may penetrate less deeply into the foil-stack-substrate assembly than depicted in FIG. 4. For example, while it is preferable that weld nuggets 480 penetrate into substrate 130, some weld nuggets 480 may instead terminate in foil stack 122. In one example, the majority or at least 75% of weld nuggets 480 penetrate into substrate 130. In another example, the majority of weld nuggets 480 are confined to foil stack 122 and, for the most part, only weld nuggets 480 incident on lower portions of side 122S relatively close to substrate 130 penetrate into substrate 130. Ultimately, the purpose of weld nuggets 480 is to join foils 120, and secure foil stack 122 to substrate 130 with sufficient strength to withstand the mechanical forces to which the foil-stack-substrate assembly are subjected in the intended application. For example, in lithium-ion batteries for electric vehicles, it may be required that the foil-stack-substrate assembly can withstand a certain shear or pull force exerted on foil stack 122 with respect to substrate 130. The magnitude of the relevant force depends on the application.

FIG. 5 shows an exemplary temporal power profile for an individual laser pulse of composite laser beam 190, in an implementation of method 100 where annular beam 210A is on for longer than center beam 210C during each laser pulse. For each pulse of laser beam 190, center beam 210C is characterized by a temporal profile 520C, and annular beam 210A is characterized by a temporal profile 520A. Center beam 210C has a pulse duration Δ_{C}, and annular beam 210A has a pulse duration Δ_{A} that exceeds Δ_{C}.

More specifically, for each pulse of laser beam 190, annular beam 210A is turned on before center beam 210C, and center beam 210C is turned off before annular beam 210A. Thus, for an initial duration δ₁ within each laser pulse, foil stack 122 is irradiated only by annular beam 210A. This initial exposure to annular beam 210A preheats the respective local area of foil stack 122 in a relatively mild fashion that conditions foil stack 122 for more intense irradiation by center beam 210C. Annular beam 210A remains on during irradiation by center beam 210C. Annular beam 210A further remains on for a duration δ₂ after center beam 210C has been turned off. The extended irradiation of foil stack 122 by annular beam 210A after exposure to center beam 210C helps control the cooling of metal that has melted during the exposure to center beam 210C. For example, this extended irradiation by annular beam 210A may prevent the formation of cracks in the corresponding weld nugget 480.

In the example depicted in FIG. 5, each of center beam 210C and annular beam 210A has only two states: on and off. Transitions between on- and off-states are instantaneous, or at least negligible compared to durations Δ_{C}, Δ_{A}, δ₁, and δ₂. For example, the transition times may be less than 10% of each of durations Δ_{C}, Δ_{A}, δ₁, and δ₂. The power levels of center beam 210C and annular beam 210A in their on-states are P_{C} and P_{A}, respectively. In the depicted example, P_{A} exceeds P_{C}. Yet, due to its smaller size, center beam 210C is more intense than annular beam 210A.

The optimal values of powers P_{A} and P_{C} and durations Δ_{C}, Δ_{A}, δ₁, and δ₂, are interrelated and further depend on other parameters, e.g., dimensions and materials of foil stack 122 and substrate 130 as well as transverse sizes of center beam 210C and annular beam 210A. In one example, power P_{C} is at least 0.5 kilowatts (kw), for example in the range between 0.5 and 5 kW. Power P_{A} may be in this same range. In the example depicted in FIG. 5, power P_{A} exceeds P_{C}. This relationship has been found advantageous in certain scenarios. Duration Δ_{C} may be in the range between 20 and 500 microseconds (μs). Duration Δ_{A} may exceed Δ_{C} by between 5% and 50%, and duration δ₁ may exceed duration δ₂. In another example, the largest transverse 1/e² extent of center beam 210C is at most 50 μm at foil stack 122, power P_{C} is at least 1 kW, and duration Δ_{C} is in the range between 50 and 200 microseconds. In most scenarios, the repetition rate of pulses of laser beam 190 is limited by the time it takes to move laser beam 190 from one incidence location 392 to the next. The pulse repetition rate may be on the order of a kilohertz.

Although not depicted, one or both of center beam 210C and annular beam 210A may be ramped on and/or ramped off instead of being turned on and off instantaneously. Additionally, the power of one or both of center beam 210C and annular beam 210A may be changed during their respective on-states.

Furthermore, method 100 may adjust the properties of laser beam 190 during scanning. Such adjustments may include changing power, pulse duration, and/or size of one or both of center beam 210C and annular beam 210A. In one implementation, method 100 adjusts the peak power of center beam 210C, and optionally also of annular beam 210A, according to the distance along the propagation direction of laser beam 190 from incidence location 392 to substrate 130. For example, referring to the diagram of FIG. 4, to ensure that all weld nuggets 480 penetrate into substrate 130, it may be advantageous to adjust the peak power of center beam 210C according to the propagation distance from incidence location 392 to substrate 130. Thus, the peak power of center beam 210C (and optionally also of annular beam 210A) may be highest for incidence locations on top surface 122T and lowest for the incidence location 392 on side 122S closest to substrate 130.

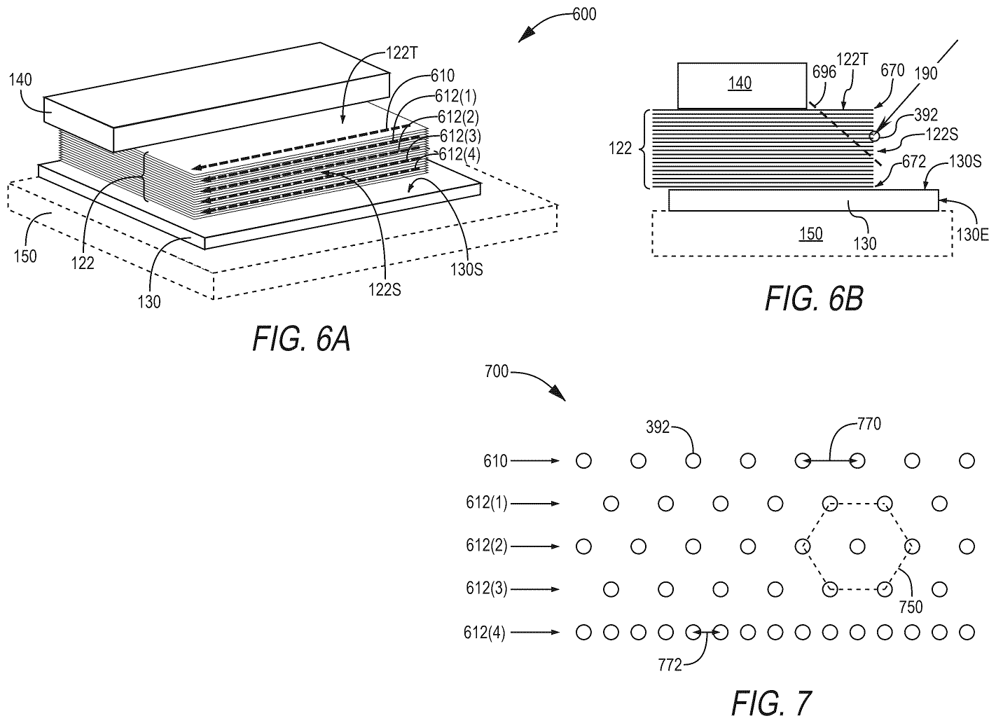

FIGS. 6A and 6B illustrate one technique 600 for scanning laser beam 190 in method 100. FIG. 6A is a perspective view showing paths traced by laser beam 190 in scanning technique 600. FIG. 6B is a cross-sectional view indicating certain geometrical features. In scanning technique 600, laser beam 190 is controlled to sequentially trace a plurality of linear paths on the surfaces of foil stack 122. Each of these paths is substantially parallel (e.g., to within 10 degrees) to the interface corner 672 (see FIG. 6B) between side 122S and substrate 130. Laser beam 190 first traces at least one path 610 on top surface 122T. Next, laser beam 190 traces a plurality of paths 612 on side 122S. In the depicted example, laser beam 190 traces four paths 612(1-4) on side 122S. More generally, laser beam 190 traces one or more paths 610 on top surface 122T, and one or more paths 612 on side 122S.

Regardless of the number of paths being traced on each of top surface 122T and side 122S, laser beam 190 is controlled to trace these paths in a particular order. In examples with two or more paths 610 being traced on top surface 122T, laser beam 190 first traces the path 610 farthest from the edge 670 (see FIG. 6B) between top surface 122T and side 122S. Laser beam 190 then proceeds to trace the path 610 second farthest from edge 670, etc. Similarly for paths 612 on side 122S, laser beam 190 first traces the path 612 farthest from interface corner 672 (path 612(1) in the depicted example) and then moves toward interface corner 672 one path 612 at a time (in the depicted example, tracing paths 612(2), 612(3), and 612(4) in the order listed). Summarizing, each path 610/612 traced by laser beam 190 is closer to interface corner 672 than any preceding paths.

Laser beam 190 may trace each path 610/612 in the same direction, as depicted in FIG. 6A. This maximizes cooling time between irradiating adjacent portions of adjacent paths. Alternatively, laser beam 190 may trace at least one of the paths in the opposite direction. For example, laser beam 190 may alternate tracing direction between paths for optimal scanning speed.

Scanning technique 600 may be generalized to irradiating paths that are not linear. In one generalization, scanning technique 600 addresses a set of regions on the surfaces of foil stack 122 with laser beam 190. Laser beam 190 first irradiates incidence locations 392 (see FIG. 3) within a region farthest from interface corner 672 and then proceeds to do the same in regions progressively closer to interface corner 672.

Incidence locations 392 irradiated with scanning technique 600 may be uniformly or non-uniformly distributed. It has been found advantageous to utilize a higher density of incidence locations 392 near interface corner 672 than elsewhere. For example, in the depicted embodiment of scanning technique 600, it is advantageous to utilize a higher density of incidence locations 392 in path 612(4) than for paths 610 and 612(1-3).

FIG. 7 illustrates one exemplary pattern 700 of incidence locations 392 that may be irradiated using scanning technique 600. FIG. 7 is best viewed together with FIGS. 6A and 6B. Pattern 700 is depicted and discussed below for an embodiment of scanning technique 600 that traces a single path 610 on top surface 122T and four paths 612(1-4) on side 122S, as depicted in FIG. 6A. Pattern 700 is readily generalized to a different number of paths on one or both of top surface 122T and side 122S. FIG. 7 shows incidence locations 392 as projected onto a common plane orthogonal to laser beam 190. An exemplary common plane 696 is indicated in FIG. 6B. Each path 610/612 may be longer than depicted in FIG. 7 so as to at least nearly span the full width 322W (see FIG. 3) of foil stack 122.

In pattern 700, each of paths 610 and 612(1-4) includes a line of equally-spaced incidence locations 392. The distance 770 between adjacent incidence locations 392 is the same for all paths except the one closest to interface corner 672, namely path 612(4). The distance 772 between adjacent incidence locations 392 in path 612(4) is only half of distance 770. In order to prevent sustained heating of the same local areas, it may be beneficial to irradiate the more densely distributed incidence locations 392 of path 612(4) in two or more interleaved passes along path 612(4), rather than in a single pass. For example, a first pass along path 612(4) may irradiate every other incidence location 392. The remaining incidence locations 392 may then be irradiated in a second pass along path 612(4). In other words, the tracing of path 612(4) may be repeated to irradiate a higher density of incidence locations 392.

In the embodiment depicted in FIG. 7, paths 610 and 612(1-3) are arranged such that the associated incidence locations 392 form a hexagonal lattice (see hexagon 750). Other lattice configurations are feasible, for example a square or rectangular lattice, or even an irregular lattice. The hexagonal lattice corresponds to a uniform distribution of incidence locations 392, apart from the increased density of incidence locations 392 along path 612(4). A uniform distribution is generally expected to provide the optimal trade-off between securing foil stack 122 to substrate 130 with the desired strength and maintaining the integrity of foils 120. The discussion, in reference to FIGS. 1 and 3, of the preferred distance between incidence locations 392 applies to scanning technique 600 and pattern 700 as well.

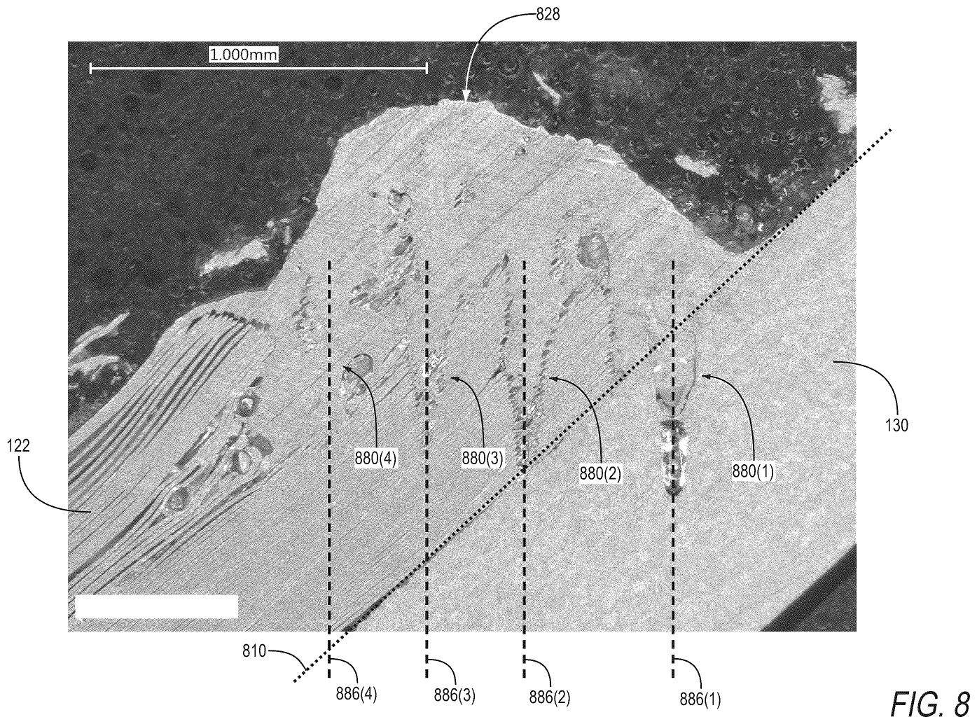

FIG. 8 is a microscope image of a cross section of one foil-stack-substrate assembly welded according to method 100, implementing scanning technique 600 and pattern 700 with a total of ten paths traced. In this example, foil stack 122 consists of 64 aluminum foils, each having a thickness of 13 μm, and substrate 130 is an aluminum substrate with a thickness of 800 μm. The foil-stack-substrate assembly was sheared to reveal individual deep-penetration weld nuggets 880. The shearing process imparted some damage on the welded assembly. Yet, the image shows four weld nuggets 880(1-4). Line 810 indicates the interface between foil stack 122 and substrate 130. At least some of weld nuggets 880 are offset from the plane of the imaged cross section, and FIG. 8 therefore does not show their full penetration depth. It is nevertheless evident that at least weld nugget 880(1) penetrates into substrate 130.

In the region closest to the exterior surface 828 of the welded foil stack 122, weld nuggets 880 merge and form a larger continuous weld. However, distinct weld nuggets 880 reach further into the material. Longitudinal axes 886 of weld nuggets 880, respectively, are discernible from the image at least for weld nuggets 880(1-3). In the depicted example, the average penetration depth of weld nuggets 880 exceeds the pitch therebetween (i.e., the pitch between longitudinal axes 886). Pitch values extracted from the cross section of FIG. 8 may not be representative of pitches between nearest-neighbor weld nuggets. The relevant nearest neighbors may be other weld nuggets outside the plane of the depicted cross section. The pitches between nearest-neighbor weld nuggets are, however, no greater than the pitches visible in FIG. 8. Assuming that the weld nuggets visible in FIG. 8 are similar to other weld nuggets outside this cross section, it is therefore possible to conclude from FIG. 8 that the average penetration depth of the weld nuggets exceeds the average pitch between nearest-neighbor weld nuggets.

Foil-stack-substrate assemblies similar to those of the FIG. 8 example have been demonstrated to withstand shear forces of more than 700 Newtons exerted on foil stack 122 with respect to substrate 130.

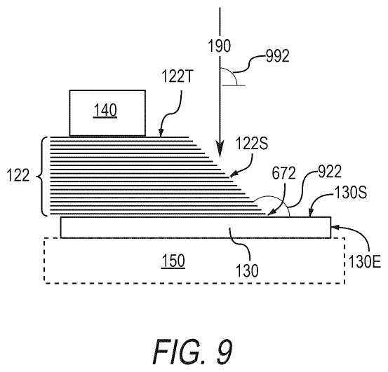

FIG. 9 illustrates a modification of method 100, wherein foils 120 are offset from each other such that side 122S is slanted away from end 130E. In other words, side 122S forms an obtuse angle 922 with support surface 130S at interface corner 672. The slanted side 122S allows for laser beam 190 to reach both top surface 122T and side 122S while propagating orthogonally to support surface 130S. Orthogonal propagation of laser beam 190 relative to support surface 130S may be preferable in some scenarios. More generally, the slanted side 122S may allow for a wider range of propagation angles 992 of laser beam 190 relative to support surface 130S. Angle 992 may be acute, normal, or obtuse.

The present invention is described above in terms of a preferred embodiment and other embodiments. The invention is not limited, however, to the embodiments described and depicted herein. Rather, the invention is limited only by the claims appended hereto.

What is claimed is:

1. A method for laser welding a metal foil stack to a metal substrate, comprising steps of:
clamping a stack of metal foils against a support surface of a metal substrate; and
irradiating the stack of metal foils with a beam of laser pulses to weld the stack of metal foils to the metal substrate, the beam being a composite beam including a center beam and an annular beam surrounding the center beam, a peak power of the center beam being at least 0.5 kilowatt for each of the laser pulses, the center beam being on for a duration of between 20 and 500 microseconds for each of the laser pulses;
wherein the step of irradiating includes:
scanning the composite beam such that (a) an initial series of the laser pulses are incident on the stack at a respective series of mutually distinct locations on a top surface of a top-most metal foil of the stack facing away from the support surface and (b) a subsequent series of the laser pulses are incident on the stack at a respective series of mutually distinct locations on a side of the stack, the side being between the support surface and the top surface, and
focusing the composite beam such that a largest transverse 1/e² extent of the center beam is less than 150 micrometers at the stack.

2. The method of claim 1, wherein each of at least some of the laser pulses forms a weld nugget that penetrates into the metal substrate.

3. The method of claim 1, further comprising arranging the metal foils such that the side of the stack is orthogonal to the support surface, to within 10 degrees, and wherein the step of irradiating includes directing the composite beam onto the stack at an oblique angle with respect to the support surface.

4. The method of claim 3, wherein the oblique angle is between 30 and 60 degrees.

5. The method of claim 1, wherein the support surface extends beyond the side of the stack.

6. The method of claim 1, wherein, for each pair of the laser pulses, respective incidence locations of the center beam on the stack is characterized by a center-to-center distance of at least 100 micrometers, as measured orthogonally to a direction of incidence of the composite beam.

7. The method of claim 1, wherein, for each pair of the laser pulses, respective incidence locations of the center beam on the stack is characterized by a center-to-center distance, as measured orthogonally to an angle of incidence of the composite beam, that exceeds the largest transverse 1/e² dimensions of the center beam at the stack.

8. The method of claim 1, wherein the step of irradiating includes a step of sequentially tracing, with the composite beam, a plurality of paths parallel to an interface corner between the side of the stack and the support surface, each of the paths being closer than each preceding one of the paths to the interface corner, at least one of the paths being traced during irradiation by the initial series of laser pulses and at least one other one of the paths being traced during irradiation by the subsequent series of laser pulses.

9. The method of claim 8, wherein:
the paths include a final path nearest the interface; and
the method further comprises, after the step of sequentially tracing, a step of repeating tracing of the final path using a different set of incidence locations of the center beam on the stack than used during the step of sequentially tracing.

10. The method of claim 9, wherein incidence locations of the laser pulses delivered along the final path during the step of repeating tracing are interlaced with incidence locations of the laser pulses delivered along the final path during the step of sequentially tracing.

11. The method of claim 1, wherein the largest transverse 1/e² extent of the center beam is at most 50 micrometers at the metal foil stack, the peak power of the center beam is at least 1 kilowatt, and the duration of the center beam, for each of the laser pulses, is between 50 and 200 microseconds.

12. The method of claim 1, further comprising, for each of the laser pulses, turning on the annular beam before the center beam.

13. The method of claim 12, further comprising, for each of the laser pulses, turning off the center beam before the annular beam.

14. The method of claim 1, wherein the stack includes at least 100 metal foils.

15. The method of claim 14, wherein each of the metal foils has a thickness of at most 20 micrometers.

16. A battery, comprising:
a metal substrate having a support surface; and
a metal foil stack disposed on the support surface and being welded to the metal substrate by a plurality of weld nuggets extending into the metal foil stack from a surface of the metal foil stack, the weld nuggets including deep-penetration weld nuggets, at least some of the deep-penetration weld nuggets further extending into the metal substrate, the deep-penetration weld nuggets being oriented at an oblique angle with respect to the support surface and having an average penetration depth, from the surface of the metal foil stack, that exceeds an average pitch between nearest-neighbor deep-penetration weld nuggets.

17. The battery of claim 16, wherein the average penetration depth is at least twice the average pitch.

18. The battery of claim 16, wherein the average penetration depth exceeds 0.25 millimeters.

19. The battery of claim 16, wherein the oblique angle is between 30 and 60 degrees.

20. The battery of claim 16, wherein each metal foil is an aluminum foil, and the metal substrate is an aluminum substrate.

21. The battery of claim 16, wherein each metal foil is a copper foil, and the metal substrate is a copper substrate.
